(19) United States
(12) Patent Application Publication
(10) Pub. No.: US 2024/0093439 A1
(43) Pub. Date: Mar. 21, 2024

(54) CURING MACHINE

(71) Applicant: Wirtgen GmbH, Windhagen (DE)

(72) Inventors: Jörg Bangel, Niederwambach (DE); Harry Wenzelmann, Alpenrod (DE)

(21) Appl. No.: 18/464,324

(22) Filed: Sep. 11, 2023

(30) Foreign Application Priority Data
Sep. 15, 2022 (DE) 10 2022 123 625.0

(51) Int. Cl. E01C 23/03

(52) U.S. Cl. CPC E01C 23/03

(57) ABSTRACT

A curing machine for curing freshly-laid concrete slabs has a sprayer for spraying a curing agent—in particular, a dispersion—onto the fresh concrete slab in order to prevent premature drying out of the concrete. The curing machine includes a controller which works together with an operating unit for the automatic actuation of a pump and of shut-off elements of the liquid system of the sprayer. The controller is configured such that, by manual actuation of the operating unit, at least two operating modes from the group comprising filling mode A, spraying mode B, mixing mode C, and cleaning mode D can be selected, wherein, after selection of an operating mode, the at least one pump and the shut-off elements assigned to the selected operating mode are actuated in such a way that the selected operating mode is executed.

### RELATED APPLICATION

The present application claims priority to German Patent Application Serial No. DE 10 2022 123 625.0, filed Sep. 15, 2022, which is incorporated herein by reference.

### BACKGROUND

The invention relates to a curing machine for curing freshly-laid concrete slabs—in particular, concrete roadways extending longitudinally in the working direction.

### SUMMARY OF THE PRIOR ART

For the production of concrete roadways, slipform pavers are used, which install the concrete in the correct shape and position. The slipform paver has a smoothing device to smooth the not-yet-cured surface of the concrete slab. After the concrete slab has been smoothed, known curing machines are used, which generally have a texturing device for applying texturing to the fresh concrete slab in the transverse direction and/or longitudinal direction, in order to improve the slab's skid resistance and to increase ride comfort or to reduce the development of tire/road noise. In addition, the curing machines generally have a sprayer for spraying a curing agent—in particular, a dispersion—onto the fresh concrete slab in order to prevent the concrete from drying out prematurely.

DE 10 2014 212 853 A1 (U.S. Pat. No. 9,399,842) describes a curing machine which has not only a texturing device, but also a sprayer. The dispersion can be sprayed with the sprayer onto the surface of the concrete slab after the concrete slab has been processed with the texturing device. To apply the dispersion, the sprayer has a first group of spray nozzles which are arranged at a distance from one another on the machine frame over the entire working width. The dispersion can also be applied with a second group of spray nozzles which are provided on a carriage that can be moved over the entire working width.

The sprayers of known curing machines have a liquid system which comprises liquid lines for conducting liquid, shut-off elements for shutting off individual liquid lines, pumps for conveying a liquid in the liquid lines, a curing agent tank for holding a curing agent, a cleaning agent tank for holding a cleaning agent, and groups of spray nozzles for spraying curing agent onto the concrete slab.

The liquid system of known curing machines is designed such that different operating modes can be executed. In a filling mode, the curing agent tank can be filled with a curing agent. In a spraying mode, the curing agent is sprayed. In addition, a mixing mode is provided in which the curing agent is set in motion in the curing agent tank in order to mix the curing agent. In a cleaning or flushing mode, cleaning or flushing liquid can be conducted to the spray nozzles in order to clean the spray nozzles.

To execute the individual operating modes, it is necessary to open or close individual shut-off elements of the liquid system by hand. This procedure proves complicated and time-consuming. In addition, there is the risk of operating errors. For example, when the spray nozzles are being cleaned, if the wrong shut-off elements are opened or closed, there is the risk of cleaning liquid getting into the curing agent tank. The risk of operating errors also exists if the design of the liquid system requires the use of several pumps for conveying the liquids. If the wrong pumps are switched on or off, malfunctions will result. Furthermore, the use of several pumps leads to higher production costs.

### BRIEF SUMMARY

An object of the invention is to simplify the operation of the sprayer of a curing machine and to reduce the risk of operating errors.

The embodiments of the invention described below can comprise one or more of the features or feature combinations mentioned below. A feature denoted by an indefinite article can also be present multiple times if the indefinite article is not to be understood with an explicit indication of only one-time use. A denotation of features by a numeral, e.g., “first and second”, does not preclude that these features can be present more times than the number indicated by the numeral.

The sprayer of the curing machine according to one embodiment is characterized by a controller working together with an operating unit for automatically actuating the at least one pump and the shut-off elements of the liquid system. The controller is configured such that, by manual actuation of the operating unit, a human operator may select a selected operating mode from a selectable group of operating modes. The selectable group of operating modes includes at least two of the following operating modes: a filling mode, spraying mode, mixing mode, and cleaning mode. After selection of the selected operating mode, the at least one pump and the shut-off elements are actuated in such a way that the selected operating mode is executed. In another embodiment the selectable group includes at least three of the operating modes. In a further embodiment the selectable group includes all four of the operating modes.

If a filling mode is provided, the liquid system will be designed such that, in filling mode (A), the curing agent tank (29) is filled with a curing agent. For a spraying mode (B), the liquid system is designed such that curing agent is sprayed with the at least one group (24A, 24B, 27A, 27B) of spray nozzles (25). For a mixing mode (C), the liquid system is designed such that curing agent is set in motion in the at least one curing agent tank (29), and, for a cleaning mode (D), the liquid system is designed such that a cleaning liquid is conducted to the at least one group (24A, 24B, 27A, 27B) of spray nozzles (25).

The controller controls the shut-off elements assigned to the operating mode so that liquid flows along the liquid paths or liquid lines assigned to the operating mode. Consequently, the shut-off elements assigned to the operating mode are automatically, and preferably electrically, actuatable shut-off elements which can be actuated by the controller. The controller can also be configured such that at least three operating modes or all operating modes can be selected and executed by manual actuation of the operating unit. If not all operating modes can be selected, the shut-off element assigned to the non-selectable operating mode can also be an only manually-actuatable shut-off element, or the shut-off elements assigned to the non-selectable operating modes can be manually-actuatable shut-off elements. The possibility of selecting an operating mode by means of an operating unit and the automatic execution of the selected operating mode facilitates operation of the curing machine and reduces the risk of operating errors. For the selection of an operating mode, the operating unit can have, for example, mechanical buttons and/or switches and/or a touchscreen. By selecting an operating mode from the available operating modes, it can be ruled out, for example, that, due to an incorrect manual operation of the shut-off elements, cleaning liquid gets into the curing agent tank, and therefore not curing agent, but cleaning liquid is sprayed onto the fresh concrete slab.

Possible operating errors can also be ruled out by the controller being configured such that several operating modes cannot be selected simultaneously. For example, it can be ruled out that spraying mode and mixing mode are performed simultaneously.

The liquid system can be designed such that its liquid lines form a supply line path for conducting liquid from an external curing agent source into the curing agent tank, wherein the controller is configured such that, in filling mode, the at least one pump is activated so that liquid is pumped from the external curing agent source into the curing agent tank. In filling mode, the controller is also configured such that the shut-off elements assigned to the selected filling mode in the liquid system are actuated so that the liquid flows along the supply line path. Consequently, curing agent can be provided on the construction site in an external tank, and the curing agent can be transferred from that tank into the curing agent tank.

The liquid lines of the liquid system can further form a curing agent supply path for conducting liquid from the curing agent tank to the at least one group of spray nozzles, wherein the controller is configured such that, in spraying mode, the at least one pump is activated so that liquid is pumped from the curing agent tank to the at least one group of spray nozzles. In spraying mode, the controller is also configured such that, in the liquid system, the shut-off elements assigned to the selected spraying mode are actuated so that the liquid flows along the curing agent supply path.

Furthermore, the liquid system can comprise a curing agent circulation path for conducting liquid from the curing agent tank back into the curing agent tank, wherein the controller is configured such that, in mixing mode, the at least one pump is activated so that liquid is pumped from the curing agent tank back into the curing agent tank. In mixing mode, the controller is also configured such that, in the liquid system, the shut-off elements assigned to the selected mixing mode are actuated so that the liquid flows along the curing agent circulation path.

Furthermore, the liquid system can comprise a cleaning agent path for conducting cleaning agents from the cleaning agent tank to the at least one group of spray nozzles, wherein the controller is configured such that the at least one pump is activated in cleaning mode so that liquid is pumped from the cleaning agent tank to the at least one group of spray nozzles. In cleaning mode, the controller is also configured such that, in the liquid system, the shut-off elements assigned to the selected cleaning mode are actuated so that the liquid flows along the cleaning agent path. However, cleaning does not need to include the flushing of the spray nozzles. During cleaning, the spray nozzles can also be closed, so that cleaning agent cannot get onto the fresh concrete slab.

Another aspect of the invention is that the liquid system is designed such that, in filling mode, spraying mode, mixing mode, and cleaning mode, only a single pump is provided for conveying liquid. Since pumps are relatively complex components compared to shut-off elements or lines, production costs can be reduced when there is only one pump.

In one embodiment with only a single pump, the liquid system is designed such that the single pump is arranged in a common line section of the supply line path, curing agent supply line path, curing agent circulation path, and cleaning agent path. The respective operating mode can be executed by the controller actuating individual shut-off elements, so that the single pump conveys the respective liquid to, for example, the nozzles of the at least one nozzle group.

A further aspect of the invention lies in the mixing unit for mixing the curing agent in the curing agent tank. The invention does not make use of the mechanical stirrers provided in the known curing machines. The mixing unit according to the invention is based upon a circulation of the curing agent located in the curing agent tank, which is effected by curing agent being fed to the tank and discharged from the tank. The mixing unit, which comprises a first lance-shaped feed line and a second lance-shaped feed line, which are skewed in relation to each other, is arranged in the curing agent circulation path in such a way that curing agent is fed to the curing agent tank via the lance-shaped feed lines, and curing agent is discharged from the curing agent tank via an outlet. The mixing unit with the skewed feed lines can be inserted from above into an opening of the curing agent tank and removed again.

One embodiment provides that the mixing unit have a mounting part which can be fastened to the curing agent tank and is designed such that the lance-shaped feed lines, in an operating position in which the lance-shaped feed lines are arranged skewed in relation to each other, can be fastened to the mounting part and, in a transport position, can be fastened to the mounting part, in which the feed lines are aligned in parallel. When the mixing unit is not needed, the feed lines can thus be fastened to the mounting part in a space-saving manner.

A further aspect of the invention is that the curing agent tank is designed as a replaceable unit, which can be fastened to a base part provided on the machine frame. The curing agent tank can be a commercially available IBC (intermediate bulk container) canister, which is used on construction sites anyway. If curing agent is available on the construction site in an IBC tank, in filling mode, the agent can be easily pumped from this tank into the tank located on the curing machine. Since the two tanks have the same filling volume, the one tank can be completely emptied in a pumping operation, and the other tank can be completely filled. A pumped transfer of curing agent is not necessary, however, since the curing agent tank is designed as a replaceable unit. Consequently, the empty tank can simply be replaced by a filled tank.

The at least one pump is preferably a centrifugal pump driven by a hydraulic motor, and/or the shut-off elements are preferably electromagnetically-actuatable shut-off elements. However, the pump can also be an electrically-driven pump, and the shut-off elements can also be hydraulically- or pneumatically-actuated shut-off elements.

To simplify manufacturing, individual assemblies of the sprayer can be pre-assembled units which can be placed on the machine frame and fastened to the machine frame.

### BRIEF DESCRIPTION OF THE DRAWINGS

An embodiment of the curing machine according to the invention is described in detail below with reference to the figures.

Shown are:

FIG. 1 a perspectival view of an exemplary embodiment of the curing machine according to the invention, wherein an activated transverse sprayer is shown,

FIG. 2 a perspectival view of the curing machine according to the invention, wherein an activated longitudinal sprayer is shown,

FIG. 3A a perspectival view of individual components of the sprayer of the curing machine;

FIG. 3B a front view of individual components of the sprayer of the curing machine,

FIG. 3C a side view of individual components of the sprayer of the curing machine,

FIG. 4 a perspectival view of a removed mixing unit of the sprayer,

FIG. 5 a hydraulic circuit diagram of the sprayer of the curing machine, and

FIG. 6 a table with the switching positions of the shut-off elements of the sprayer of the curing machine.

### DETAILED DESCRIPTION

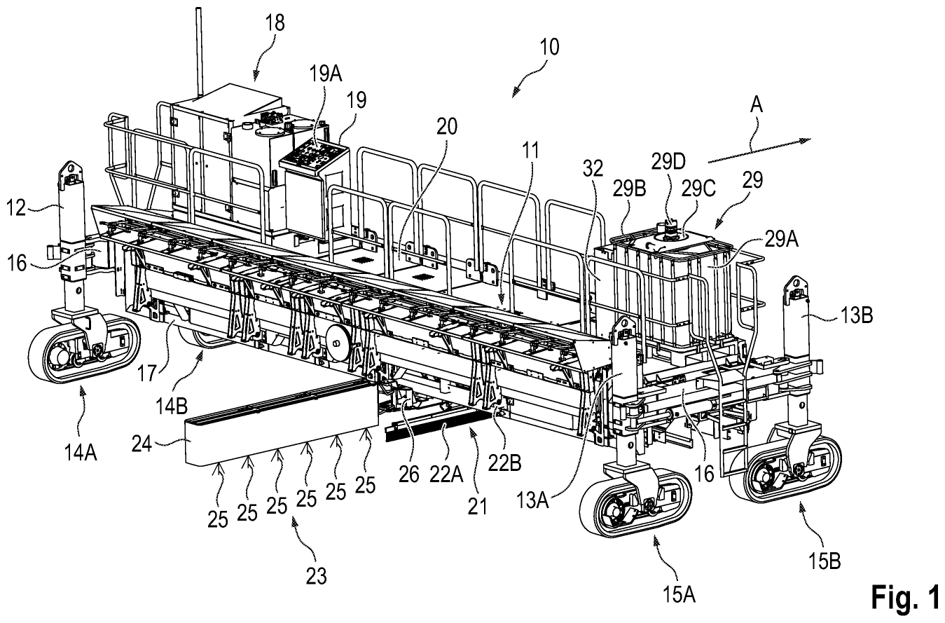

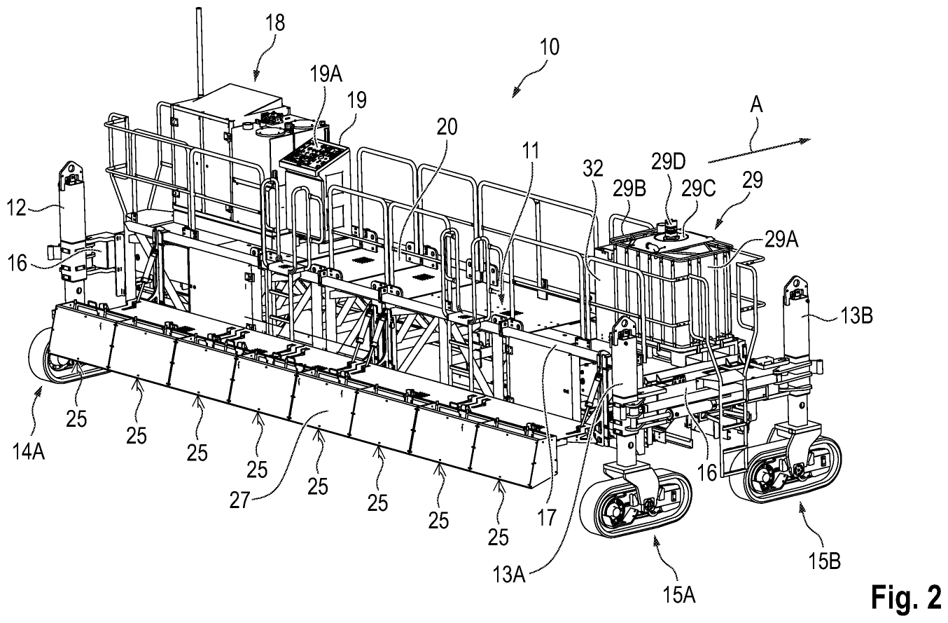

FIGS. 1 and 2 show, in a perspectival view, an exemplary embodiment of the curing machine 10 according to the invention for the curing of freshly-laid concrete slabs in particular, concrete roadways extending longitudinally in the working direction A.

The curing machine 10 has an elongated machine frame 11, which is supported in the working direction A by lifting devices 12 on the left-hand side and by lifting devices 13A, 13B on the right-hand side, to which the left-hand ground engaging units 14A, 14B and right-hand ground engaging units 15A, 15B, e.g., crawler tracks, are fastened, so that the machine frame 11 is adjustable in height with respect to the concrete slab. Wheeled ground engaging units may also be used. The working width of the machine frame 11 is a multiple of the working depth.

The machine frame 11 has longitudinal beams 16 extending in the working direction A and transverse beams 17 extending transversely to the working direction, wherein the transverse beams 17 are telescopic for variable adjustment of the working width. The working width can also be increased by using additional frame elements (not shown).

The drive unit 18 of the curing machine 10 is arranged on the left-hand side of the machine frame 11 in the working direction A. In addition to the drive unit 18, there is a control console 19 with a control panel 19A. Drive unit 18 and control console 19 are arranged on a platform 20 of the machine frame 11, which can be accessed by the machine operator.

The curing machine 10 has a working device for applying texturing to the fresh concrete slab. This working device can comprise a device 21 for applying texturing in the transverse direction and/or a device (not shown) for applying texturing in working direction A, which devices can be activated individually. FIG. 1 shows an exemplary embodiment with an activated device 21 for applying a linear texturing in the transverse direction by means of a brush assembly 22A extending in the working direction A, which brush assembly can be moved transversely to the working direction on a carriage 22B.

Furthermore, the working device comprises a sprayer 23 for applying a liquid curing agent, e.g., a dispersion, to the fresh concrete slab, which device can comprise various individually activatable spraying units for applying a curing agent. FIG. 1 shows an activated spraying unit 24, extending in the working direction A, of the sprayer 23, which unit can comprise one or more individually connectable groups of spray nozzles 25 arranged at a distance from one another. This spraying unit 24 is displaceable on a carriage 26 transversely to the working direction A. FIG. 2 shows a further spraying unit 27 activated by being folded down, which can have one or more individually connectable groups of spray nozzles arranged in the transverse direction.

The curing agent is provided in a replaceable curing agent tank 29, which is arranged on the right-hand side of the machine frame 11 in the working direction A. The curing agent tank 29 is a conventional IBC (intermediate bulk container) canister having a filling volume of 1,000 L, which has a plastic tank 29A that is enclosed by a metal basket 29B. The plastic tank 29A has on the upper side an opening 29C, which is closed with a screw cap 29D, and has an outlet 29E at the bottom.

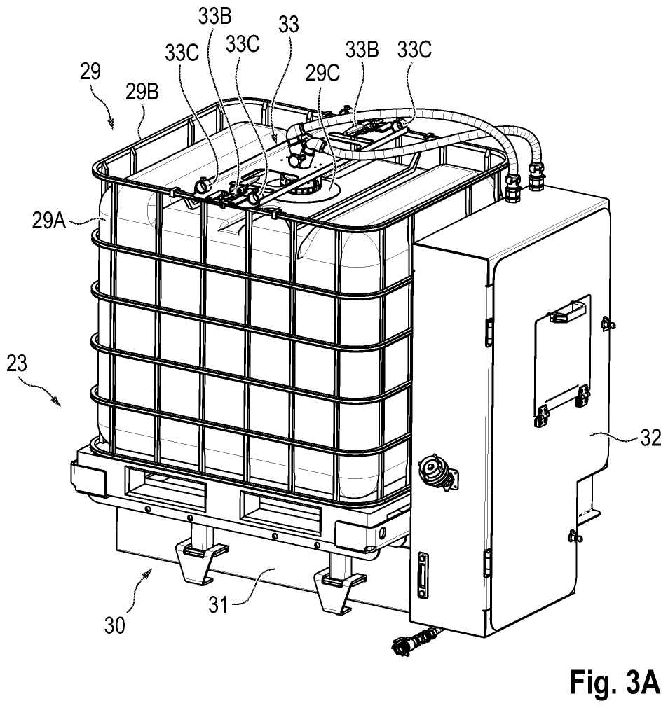

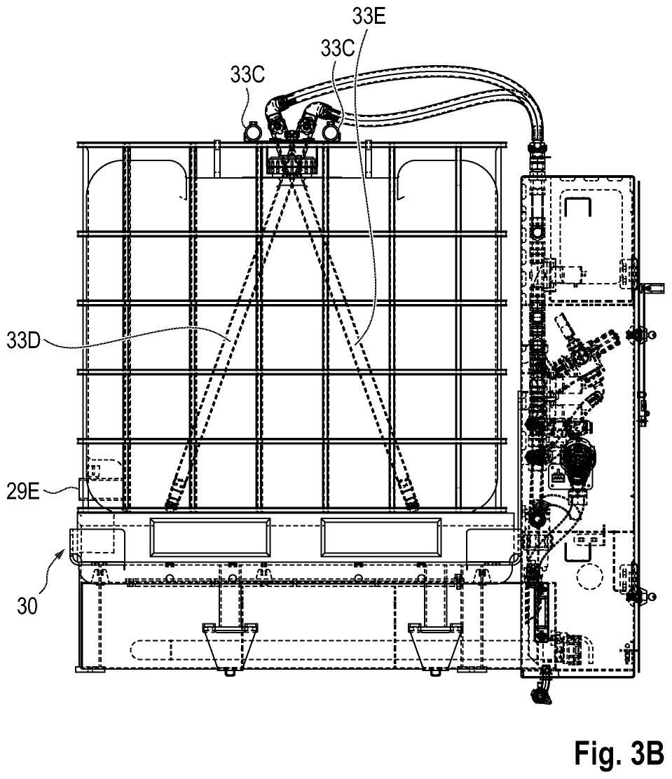

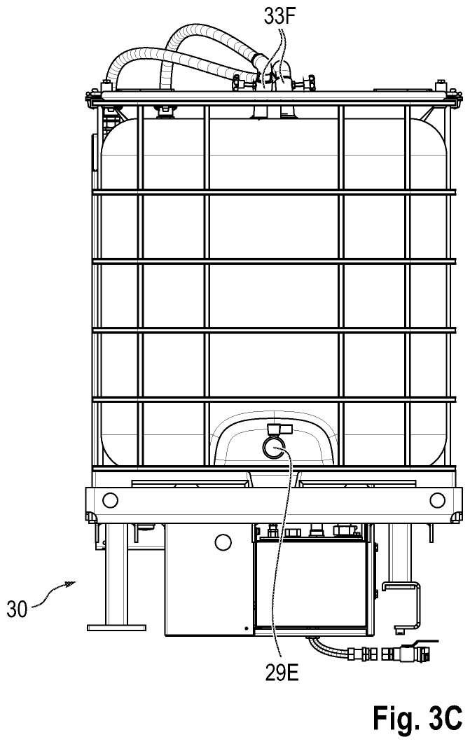

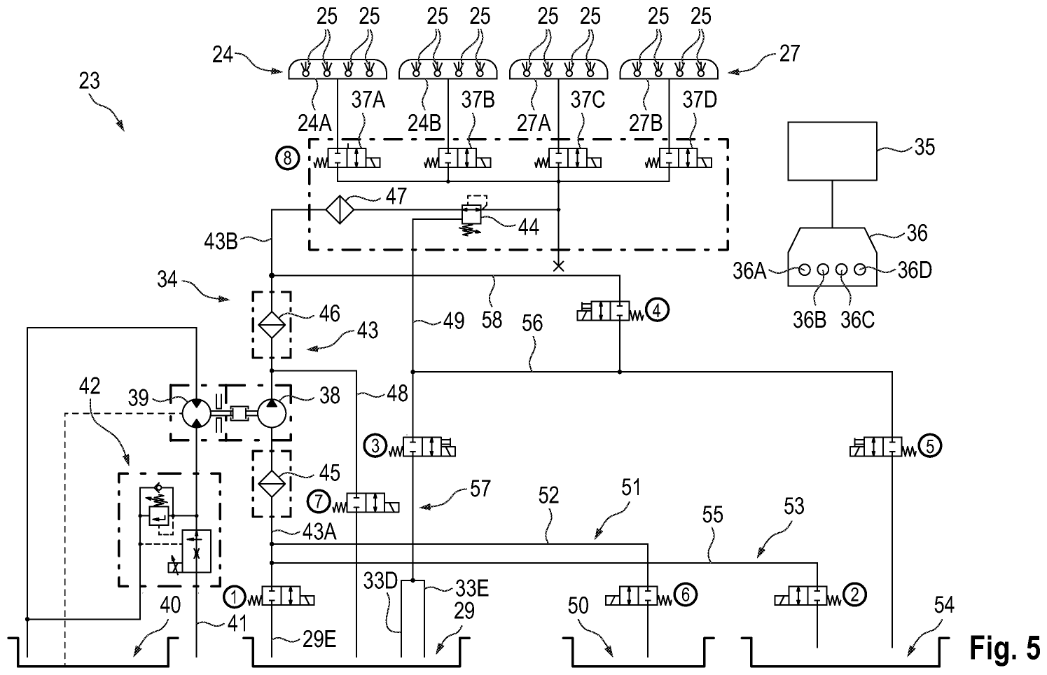

FIGS. 3A through 3C illustrate the curing agent tank 29 together with further components of the sprayer 23. The curing agent tank 29 stands as a replaceable unit on a base part 30. Below the base part 30 for the curing agent tank 29, there is a cleaning agent tank 31 for holding a cleaning agent, in which tank a heat exchanger (not shown) is arranged through which hydraulic oil of the drive unit 18 flows in order to heat the cleaning agent—in particular, water. In addition to the base part 30, there is a cabinet 32 for accommodating components of the sprayer 23, which are to be described below with reference to FIG. 5, such as liquid lines 43A, 43B, 48, 52, 55, 57 for conducting liquids, a centrifugal pump 38 for conveying liquids in the liquid lines 43A, 43B, 48, 52, 55, 57, and shut-off elements 1, 2, 3, 4, 5, 6, 7, 8 for shutting off individual liquid lines. The shut-off elements 1, 2, 3, 4, 5, 6, 7, 8 may also be referred to as shut-off valves 1, 2, 3, 4, 5, 6, 7, 8.

Furthermore, the sprayer 23 has a removable mixing unit 33 for mixing curing agent in the curing agent tank 29 and which can be inserted into the opening 29C of the curing agent tank 29 when the screw cap 29D has been unscrewed.

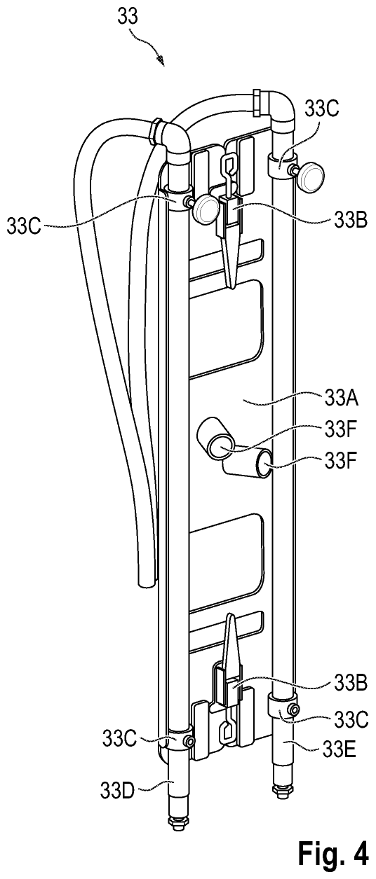

FIG. 4 shows the removed mixing unit 33 in the transport position, the unit having a flat, frame-shaped mounting part 33A, which, with lateral fastening elements 33B provided on the short sides thereof, can be fastened to the metal cage 29B of the curing agent tank 29. On the long sides of the mounting part 33A, there are fastening means 33C for releasably attaching a first lance-shaped feed line 33D and a second lance-shaped feed line 33E in the transport position in which the lance-shaped feed lines are aligned parallel to one another. In the center of the mounting part 33A, there are further fastening means 33F, e.g., sleeves, for attaching the lance-shaped first feed line 33D and second feed line 33E in the operating position, in which the feed lines are arranged skewed in relation to each other. When the mixing unit 33 is inserted into the curing agent tank 29, the feed lines 33D, 33E extend up to close to the tank base (FIGS. 3A through 3C).

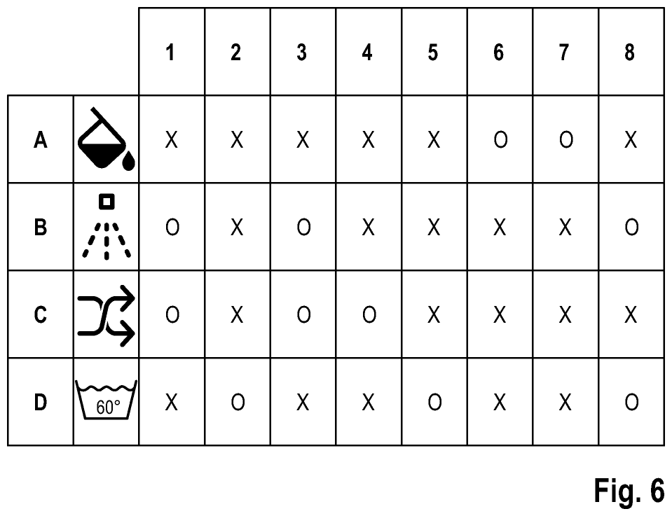

The structure and function of the sprayer 23 will be described below. FIG. 5 shows the hydraulic circuit diagram of the sprayer 23, and FIG. 6 shows a table with the switching positions of the shut-off elements thereof. The sprayer 23 provides a filling mode A, spraying mode B, mixing mode C, and cleaning mode D. The liquid system 34 of the sprayer 23 has several liquid paths to be described below, which in turn comprise several liquid lines.

The sprayer 23 has a controller 35 and an operating unit 36 that works together with the controller. For each operating mode, the operating unit 36 has an operating element 36A, 36B, 36C, 36D—for example, a pushbutton, switch, or a button of a touchscreen. By actuating an operating element 36A, 36B, 36C, 36D, one of the above-mentioned operating modes is selected, wherein the respective operating mode is executed automatically.

The controller 35 is connected via control lines (not shown in FIG. 5) to the shut-off elements described below. The controller 35 can form an independent assembly or be at least partially a component of the central control and computing unit (not shown) of the construction machine. The controller 35 can comprise, for example, a general processor, a digital signal processor (DSP) for continuously processing digital signals, a microprocessor, an application-specific integrated circuit (ASIC), an integrated circuit (FPGA) consisting of logic elements, or other integrated circuits (IC) or hardware components. A data processing program (software) can run on the hardware components in order to control the individual components of the sprayer 23. The controller 35 is configured such that individual shut-off elements are opened or closed for activation of the operating modes.

The hydraulic circuit diagram shows two spraying units 24, 27 each having two groups 24A, 24B, 27A, 27B of spray nozzles 25 for applying a curing agent. The groups 24A, 24B, 27A, 27B of spray nozzles 25 are each assigned a spray nozzle shut-off element 37A, 37B, 37C, 37D, e.g., a non-energized, spring-returned, electromagnetically-actuated 2/2-way valve, so that the supply of liquid to the spray nozzles 25 can be interrupted. By opening or closing the respective spray nozzle shut-off elements, curing agent can be applied to the fresh concrete slab by one of the spraying units 24, 27 over a specific working width. The spray nozzle shut-off elements are also referred to below as shut-off elements 8 (FIG. 6).

The liquids are conveyed in the liquid system 34 by means of only a single hydraulic pump 38, which is driven by a single hydraulic motor 39. However, several pumps can also be provided. In order to operate the hydraulic motor 39, hydraulic fluid flows from a hydraulic fluid tank 40 to the hydraulic motor and from the hydraulic motor into the hydraulic fluid tank. For the sake of simplicity, the line sections 41 leading from the hydraulic fluid tank 40 to the hydraulic motor 39 are only partially shown in FIG. 5. In order to regulate the volume flow, a flow control valve device 42 known to the person skilled in the art is provided, whose further description is unnecessary.

The curing agent is provided in the replaceable curing agent tank 29, and in particular the IBC (intermediate bulk container) (FIG. 3). During spraying mode B, curing agent flows via a curing agent supply path 43, which comprises a liquid line 43A leading to the inlet of the pump 38 and a liquid line 43B leading away from the outlet of the pump, from the curing agent tank 29 to the inlets of the spray nozzle shut-off elements 37A, 37B, 37C, 37D (8), at whose outlets the spray nozzles 25 are connected. A first shut-off element 1, e.g., a non-energized, spring-returned, electromagnetically-actuated 2/2-way valve, which in the table is also denoted by “1”, is interposed in the liquid line 43A leading to the inlet of the pump 38 and connected to the outlet 29E of the curing agent tank 29. A pressure relief valve 44, which opens at an adjustable overpressure, is interposed in the liquid line 43B leading from the outlet of the pump 38. In addition, liquid filters 45, 46, 47, e.g., replaceable filter cartridges, are provided in the curing agent supply path 43 upstream and downstream of the pump 38. A liquid line 48, which leads to the curing agent tank 29, branches off from the liquid line 43B leading away from the outlet of the pump 38. A shut-off element 7—in particular, an electromagnetically-actuated 2/2-way valve—is interposed in this liquid line 48. A liquid line 49 leads from the outlet of the pressure relief valve 44 to the curing agent tank 29, in which line a shut-off element 3—in particular, an electromagnetically-actuated 2/2-way valve—is interposed.

When the operating element 36A is actuated for the spraying mode B, the controller 35 opens the shut-off element 1 and the respective spray nozzle shut-off elements 8 (37A, 37B, 37C, 37D) as well as the shut-off element 3, and puts the hydraulic motor 39 of the pump 38 into operation, so that curing agent flows to the spray nozzles 25 of the respective nozzle group 24A, 24B, 27A, 27B. The shut-off element 7 is closed. Since the shut-off element 3 is open in spraying mode, the curing agent can flow back into the curing agent tank 29 if a pressure is exceeded. FIG. 6 shows in a table the switching positions of the respective shut-off elements, wherein an open shut-off element is represented by “0”, and a closed shut-off element by “X”.

In filling mode A, the curing agent tank 29 is filled with curing agent, wherein curing agent is provided with an external curing agent source 50, e.g., in an external curing agent tank—in particular, an IBC container. The curing agent flows, via a supply line path 51, from the external curing agent tank 50 into the internal curing agent tank 29 arranged on the machine frame 11. The supply line path 51 comprises a liquid line 52 which departs from the external curing agent tank 50 and leads to the liquid line 43A leading to the inlet of the pump 38, the liquid line 43A leading to the inlet of the pump 38 and the liquid line 48, which branches off from the liquid line 43B leading from the outlet of the pump 38, and leads to the curing agent tank 29. In filling mode A, the controller 35 puts the pump 38 into operation and opens the shut-off elements 6 and 7. The shut-off element 1 is closed (FIG. 6).

When cleaning mode D is activated, a cleaning agent flows along a cleaning agent path 53. The cleaning agent is provided in a cleaning agent tank 54, wherein the cleaning agent can be warm water. A cleaning agent feed line 55 leads from the cleaning agent tank 54 to the liquid line 43A, leading to the inlet of the pump 38, and a cleaning agent discharge line 56, which leads back to the cleaning agent tank 54, branches off from the liquid line 49 connected to the overpressure connection of the pressure limiting valve 44. A shut-off element 2—in particular, a non-energized, spring-returned, electromagnetically-actuated 2/2-way valve—is interposed in the cleaning agent feed line 55, and a shut-off element 5—in particular, an electromagnetically-actuated 2/2-way valve, is interposed in the cleaning-agent discharge line 56. In cleaning mode D, the controller 35 puts the pump 38 into operation, and opens the shut-off elements 2, 5, 8 and leaves the shut-off elements 1, 3, 4, 6, 7 (FIG. 6) closed, so that warm water flows along the cleaning agent path 53 to the spray nozzles 25. It should be noted that the shut-off elements 1, 3, 4, 6, 7 do not have to be actively closed by applying a control voltage, since these shut-off elements are spring-returned. When an overpressure is exceeded, cleaning agent flows back into the cleaning agent tank 54 along the cleaning agent discharge line 56. If cleaning mode D is also intended to include flushing the spray nozzles 25, for which purpose the shut-off elements 8 are opened, cleaning agent must be prevented from reaching the fresh concrete slab. In the case of the spray nozzles for longitudinal spraying, which are arranged transversely to the working direction, this can be achieved with a collecting trough arranged under the spray nozzles. In cleaning mode D, the spray nozzles for transverse spraying arranged in the longitudinal direction are moved to one or the other side of the construction machine into a position at the edge of the roadway. If the spray nozzles are not to be flushed, the shut-off elements 8 are closed.

When mixing mode C is activated, curing agent circulates in a curing agent circulation path 57 in order to mix the curing agent in the curing agent tank 29. The mixing of the curing agent in the curing agent tank 29 is therefore not effected by the use of a stirrer, but by curing agent flowing through the tank.

The curing agent circulation path 57 comprises the liquid line 43A, leading to the inlet of the pump 38, and a line section of the liquid line 43B, leading from the outlet of the pump, a bypass line 58 which branches off from the liquid line 43B leading from the pump 38 and leads, via a line section of the cleaning agent discharge line 56, to the liquid line 49 connected to the overpressure connection of the pressure relief valve 44. A further shut-off element 4—in particular, a non-energized, spring-returned, electromagnetically-actuated 2/2-way valve—which is actuated by the controller 35, is interposed in the bypass line 57. In mixing mode C, the controller 35 puts the pump 38 into operation, and opens the shut-off elements 1, 3, 4 and leaves the shut-off elements 2, 5, 6, 7, 8 (FIG. 3) closed, so that curing agent flows along the curing agent circulation path 57, wherein curing agent from the curing agent tank 29 flows to the lance-shaped first and second feed lines 33E, 33D, through the skewed feed lines 33E, 33D into the curing agent tank 29, and through the outlet 29E at the bottom of the tank 29 back out of the tank. The feed lines 33E, 33D preferably extend to close to the tank bottom. As a result, a liquid flow is generated in the curing agent tank 29, which flow leads to a movement of the liquid in the tank and thus to a mixing of the liquid. The liquid is circulated or swirled in the tank. It has been shown in experiments that supplying the liquid via the two skewed lines leads to improved mixing.

The controller 35 or the operating unit 36 can be configured such that only a single operating mode can be selected and thus activated. This avoids operating errors. However, it is also possible for several, i.e., at least two, operating modes to be able to be executed simultaneously, if this is to be possible.

1. A self-propelled curing machine for curing a freshly laid concrete roadway extending in a working direction, the curing machine comprising:
a machine frame;
a plurality of ground engaging units configured to support the machine frame from a ground surface;
a sprayer supported from the machine frame for applying a curing agent to the freshly laid concrete roadway, the sprayer including a liquid system including a plurality of liquid lines configured to conduct liquid, a plurality of shut-off valves for shutting off individual liquid lines, at least one pump for conveying a liquid in the liquid lines, at least one curing agent tank for holding a curing agent, at least one cleaning agent tank for holding a cleaning agent, and at least one group of spray nozzles for spraying the curing agent onto the freshly laid concrete roadway;
an operating unit configured for manual input by a human operator of a selection of a selected operating mode from a selectable group, the selectable group including at least two of the following operating modes:
a filling mode wherein the liquid system is configured such that the curing agent tank is filled with curing agent;
a spraying mode wherein the liquid system is configured such that curing agent is sprayed with the at least one group of spray nozzles;
a mixing mode wherein the liquid system is configured such that curing agent is set in motion in the at least one curing agent tank; and
a cleaning mode wherein the liquid system is configured such that cleaning agent is conducted to the at least one group of spray nozzles; and
a controller configured to receive the selection of the selected operating mode from the operating unit and to actuate the at least one pump and the shut-off valves such that the selected operating mode is executed.

2. The self-propelled curing machine of claim 1, wherein:
the controller is configured such that the selectable group includes at least three of the operating modes.

3. The self-propelled curing machine of claim 1, wherein:
the controller is configured such that the selectable group includes all four of the operating modes.

4. The self-propelled curing machine of claim 1, wherein:
the controller is configured such that a plurality of operating modes cannot be selected simultaneously.

5. The self-propelled curing machine of claim 1, wherein:
the liquid lines of the liquid system form a supply line path for conducting liquid from an external curing agent source into the curing agent tank; and
the controller is configured such that in the filling mode the at least one pump is activated such that liquid is pumped from the external curing agent source into the curing agent tank.

6. The self-propelled curing machine of claim 1, wherein:
the liquid lines of the liquid system form a curing agent supply path for conducting liquid from the curing agent tank to the at least one group of spray nozzles; and
the controller is configured such that in the spraying mode the at least one pump is activated such that liquid is pumped from the curing agent tank to the at least one group of spray nozzles.

7. The self-propelled curing machine of claim 1, wherein:
the liquid lines of the liquid system form a curing agent circulation path for conducting liquid from the curing agent tank back into the curing agent tank; and
the controller is configured such that in the mixing mode the at least one pump is activated such that liquid is pumped from the curing agent tank back into the curing agent tank.

8. The self-propelled curing machine of claim 1, wherein:
the liquid lines of the liquid system form a cleaning agent path for conducting cleaning agent from the cleaning agent tank to the at least one group of spray nozzles; and
the controller is configured such that in the cleaning mode the at least one pump is activated such that liquid is pumped from the cleaning agent tank to the at least one group of spray nozzles.

9. The self-propelled curing machine of claim 1, wherein:
the at least one pump of the liquid system includes only a single pump for conveying liquid in all operating modes of the selectable group.

10. The self-propelled curing machine of claim 9, wherein:
the liquid lines of the liquid system form a supply line path for conducting liquid from an external curing agent source into the curing agent tank;
the liquid lines of the liquid system form a curing agent supply path for conducting liquid from the curing agent tank to the at least one group of spray nozzles;
the liquid lines of the liquid system form a curing agent circulation path for conducting liquid from the curing agent tank back into the curing agent tank;
the liquid lines of the liquid system form a cleaning agent path for conducting liquid from the cleaning agent tank to the at least one group of spray nozzles; and
the single pump is arranged in a common line section of the supply line path, the curing agent feed path, the curing agent circulation path and the cleaning agent path.

11. The self-propelled curing machine of claim 1, wherein:
the liquid lines of the liquid system form a curing agent circulation path for conducting liquid from the curing agent tank back into the curing agent tank;
the liquid system includes a mixing unit including a first lance-shaped feed line and a second lance-shaped feed line which are skewed in relation to each other, the mixing unit being arranged in the curing agent circulation path such that curing agent is fed through the lance-shaped feed lines into the curing agent tank;
the curing agent tank includes an outlet for discharging the curing agent; and
the controller is configured such that in the mixing mode the at least one pump is activated such that liquid is pumped from the outlet of the curing agent tank and back into the curing agent tank through the lance-shaped feed lines.

12. The self-propelled curing machine of claim 11, wherein:
the curing tank includes an opening; and
the mixing unit is configured such that the first lance-shaped feed line and the second lance-shaped feed line can be inserted into the opening of the curing tank.

13. The self-propelled curing machine of claim 11, wherein:
the mixing unit includes a mounting part configured to be fastened to the curing agent tank, the mounting part being configured such that in an operating position the first lance-shaped feed line and the second lance-shaped feed line can be fastened to the mounting part such that the first lance-shaped feed line and the second lance-shaped feed line are skewed in relation to each other, and the mounting part being configured such that in a transport position the first lance-shaped feed line and the second lance-shaped feed line can be fastened to the mounting part such that the first lance-shaped feed line and the second lance-shaped feed line are essentially parallel to each other.

14. The self-propelled curing machine of claim 1, wherein:
the curing agent tank is configured as a replaceable unit which can be fastened to a base part provided on the machine frame.

15. The self-propelled curing machine of claim 14, wherein:
the curing agent tank is configured as an IBC (intermediate bulk container) canister.

16. The self-propelled curing machine of claim 1, wherein:
the at least one pump is a centrifugal pump.

17. The self-propelled curing machine of claim 1, wherein:
the shut-off valves are electromagnetically actuatable shut-off valves.
